(19) United States
(12) Patent Application Publication
(10) Pub. No.: US 2016/0253754 A1
(43) Pub. Date: Sep. 1, 2016

(54) SYSTEMS AND METHODS FOR AUTOMATING SECURITIES TRADING

(71) Applicant: TEVEL APOLO TRADE TECHNOLOGIES LTD., Ramat Gan (IL)

(72) Inventors: Arie Hacohen BEN-PORAT, Tel-Aviv (IL); Naftali FEIVELSON, Tel-Aviv (IL); Yaacov GREENSTEIN, Maaleh Adumim (IL); Dvora GERSHON, Modiin Illit (IL)

(21) Appl. No.: 14/633,225

(22) Filed: Feb. 27, 2015

(51) Int. Cl. G06Q 40/04

(52) U.S. Cl. CPC G06Q 40/04

(57) ABSTRACT

A method, system and computer program product for automatic securities trading. A graphical user interface comprising one or more spreadsheets is provided. Each of the spreadsheets comprises: a first section for receiving and displaying securities data; and a second section for receiving and displaying trading orders. Each of the trading orders comprises an execution trigger parameter, a volume parameter, a price parameter and a status parameter, which parameters are defined in spreadsheet cells. The securities data in the first section is repeatedly updated and the execution trigger parameters of the trading orders are repeatedly evaluated. Trading orders are executed responsive to a determination that the condition specified by the execution trigger parameter associated therewith is met.

### TECHNICAL FIELD

The present disclosure relates to electronic trading in general, and to computerized platforms for trading securities, in particular.

### BACKGROUND

Securities trading have become prevalent in modern days economics. Traders can buy and sell stocks, bonds, options, mutual funds, future contracts, and likewise tradable financial assets in a vast variety of markets and stock exchanges around the globe.

While in the past traders usually had to relay the trading orders to the market through a broker person, nowadays with the advent of computer technology and communications, trading orders may be sent to the market electronically for execution without requiring any middle-man, using for example the World-Wide-Web or faster direct networks.

### BRIEF SUMMARY

One exemplary embodiment of the disclosed subject matter is a computerized system comprising: a graphical user interface configured to provide a workspace comprising one or more spreadsheets, each of the one or more spreadsheets comprising: a first section comprising a plurality of spreadsheet cells for displaying securities data of one or more securities selected by a user; a second section comprising a plurality of segments composed of spreadsheet cells for receiving one or more trading orders of one or more securities, wherein each segment is associated with a trading order of a security, wherein each segment comprises an execution trigger cell, a volume cell, a price cell and a status cell, wherein the execution trigger cell defines a condition for executing the trading order, wherein the volume cell defines a volume of the security to be traded, wherein the price cell defines a price for the security in the trading order, wherein the status cell indicates an execution status of the trading order; a processor configured to repeatedly retrieve the securities data and update the first section; wherein said processor is further configured to evaluate the execution trigger cell of each segment, wherein responsive to the condition of the execution trigger cell being met, said processor is configured to send the trading order for execution; wherein said processor is further configured to update the status cell in response to the trading order being completed successfully.

Another exemplary embodiment of the disclosed subject matter is a computer-implemented method comprising: repeatedly retrieving securities data of one or more securities and updating a first section of a spreadsheet, wherein the spreadsheet is displayed by a graphical user interface of a computer; receiving, using the spreadsheet, one or more trading orders of the one or more securities, each of which trading orders comprises an execution trigger parameter, a volume parameter, a price parameter and a status parameter, wherein the execution trigger parameter defines a condition for executing the trading order, wherein the volume parameter defines a volume of the security to be traded, wherein the price parameter defines a price for the security in the trading order, wherein the status parameter indicates an execution status of the trading order, wherein the one or more trading orders are received and displayed in a second section of the spreadsheet, wherein each trading order is defined in a segment of the second section, wherein each parameter is defined in a spreadsheet cell; evaluating the execution trigger parameter of each trading order; responsive to the condition of the execution trigger parameter being met, sending the trading order for execution; and, updating the status parameter in response to the trading order being completed successfully, whereby the spreadsheet is updated to reflect the successful completion of the trading order; wherein said repeatedly retrieving, said receiving, said evaluating, said sending and said updating are performed by a processor.

Yet another exemplary embodiment of the disclosed subject matter is a computer program product comprising a computer readable storage medium retaining program instructions, which program instructions when read by a processor, cause the processor to perform a method comprising: repeatedly retrieving securities data of one or more securities and updating a first section of a spreadsheet, wherein the spreadsheet is displayed by a graphical user interface of a computer; receiving, using the spreadsheet, one or more trading orders of the one or more securities, each of which is trading orders comprises an execution trigger parameter, a volume parameter, a price parameter and a status parameter, wherein the execution trigger parameter defines a condition for executing the trading order, wherein the volume parameter defines a volume of the security to be traded, wherein the price parameter defines a price for the security in the trading order, wherein the status parameter indicates an execution status of the trading order, wherein the one or more trading orders are received and displayed in a second section of the spreadsheet, wherein each trading order is defined in a segment of the second section, wherein each parameter is defined in a spreadsheet cell; evaluating the execution trigger parameter of each trading order; responsive to the condition of the execution trigger parameter being met, sending the trading order for execution; and, updating the status parameter in response to the trading order being completed successfully, whereby the spreadsheet is updated to reflect the successful completion of the trading order.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A and 1B show a graphical user interface of a computerized trading system by which the disclosed subject matter may be employed, in accordance with some exemplary embodiments of the disclosed subject matter;

FIG. 2 shows a flowchart diagram of a method, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

One technical problem dealt with by the disclosed subject matter is to provide a computerized trading system that allows users to specify trading orders and set conditions for executing them, in a simple and intuitive manner. In some exemplary embodiments, the trading system may allow users to define trading strategies composed of several trading orders which may be intertwined, without requiring use of a programming language.

One technical solution is to provide a computerized trading system having a graphical user interface in a spreadsheet form. The spreadsheet is composed of a plurality of cells organized as a matrix with rows and columns. Each cell may hold a distinct value. A cell value may be specified nominally, or as a formula of one or more variables. A formula variable may refer to another cell in the spreadsheet, whereby the value of the referring cell becomes dependent on the value of the referred cell. A plurality of spreadsheets may be concatenated together in a single context, such as a workspace, file, or the like, wherein a cell in one spreadsheet may refer to one or more cells in other spreadsheets as well. In accordance with the disclosed subject matter, a spreadsheet may comprise a first section for storing and displaying data related to one or more securities selected by the user, and a second section for receiving user input specifying trading orders and setting conditions for executing them, wherein cell entries of the second section may refer to one or more cells of the first section. In some exemplary embodiments, the spreadsheet may comprise a third section for receiving user input specifying one or more trading strategies, which strategies may be composed of one or more of the trading orders specified in the second section. In some exemplary embodiments, a trading strategy may include a condition to execute the respective one or more trading orders repetitively.

One technical effect of utilizing the disclosed subject matter is providing a generic and user friendly trading platform that allows users to build and automatically execute composite and elaborated trading strategies without requiring previous technical knowledge or dedicated programming skills Another technical effect is to provide a user interface which allows users to view and understand trading strategies which are presented in the user interface in a relatively easy manner.

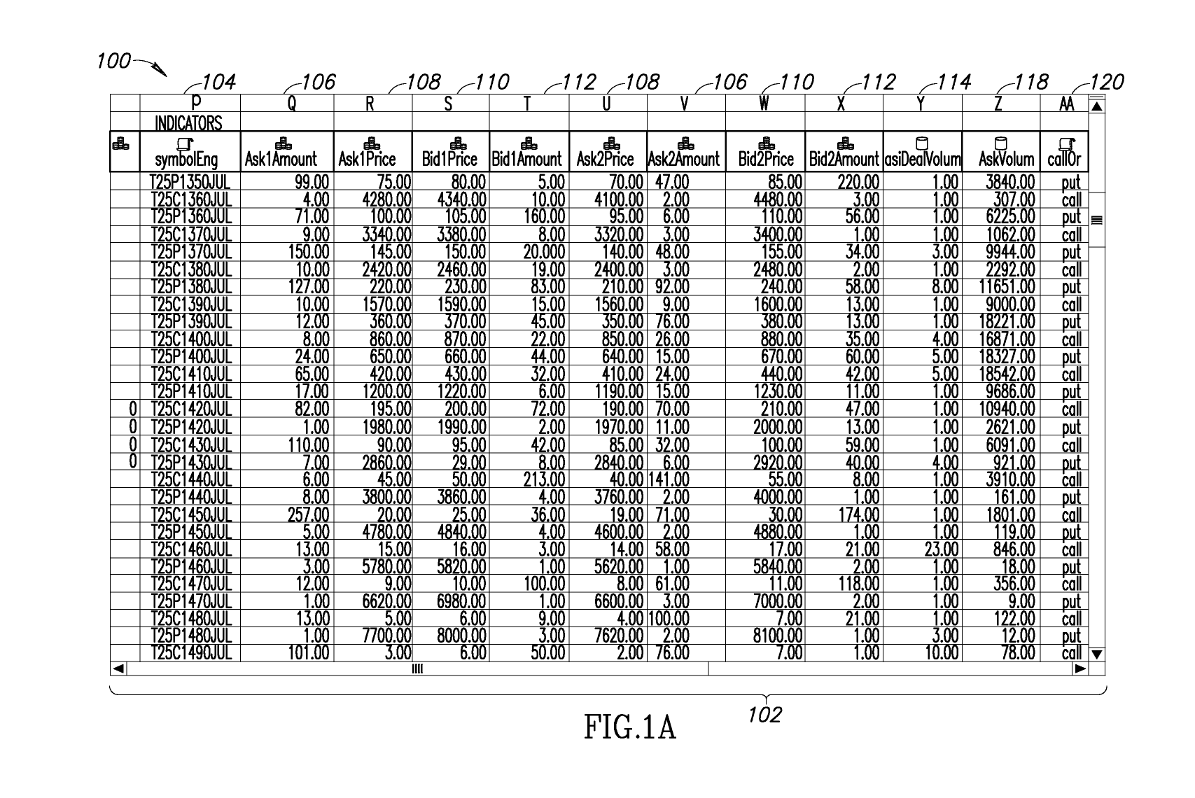

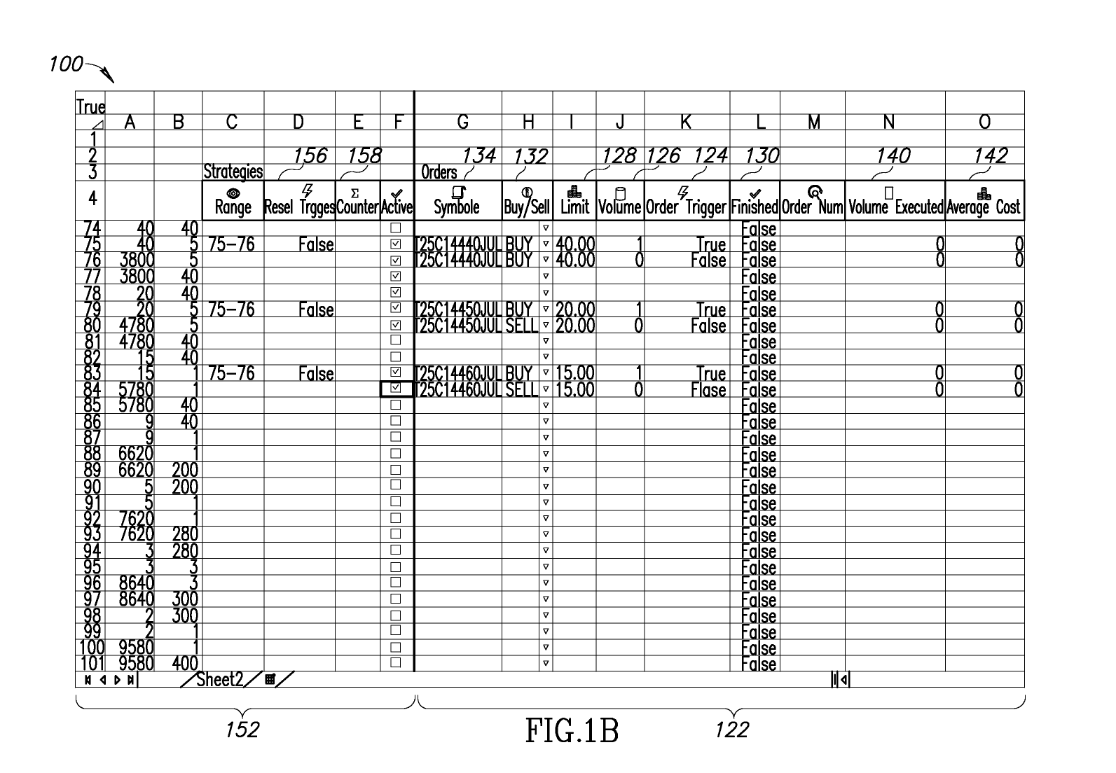

Referring now to FIGS. 1A and 1B showing a Graphical User Interface 100 of a computerized trading system by which the disclosed subject matter may be employed, in accordance with some exemplary embodiments of the disclosed subject matter.

In some exemplary embodiments, a workspace comprising one or more spreadsheets may be provided and displayed to a user by Graphical User Interface 100. Each of which spreadsheets may comprise a First Section 102 for storing and displaying securities data related to one or more securities selected by a user. The securities data may include market data, such as current bid and ask information, volume information or the like. The securities data may include fundamental data, such as sales information of the underlying company, cash flow information, data derived from financial statements, or the like. The securities data may be retrieved and updated in real time from the data source, for example, the relevant market or a reporting system. Additionally or alternatively, the securities data may be retrieved from a historic data source to be used in back testing. The securities data may be retrieved from multiple sources and trading platforms, for example, one or more stock exchanges, one or more foreign exchange markets, and the like. The displayed securities data may be organized in segments of contiguous cells, for example a row or a column, such that each of which segments may be associated with a single security. Each cell of a segment may be associated with a parameter of the corresponding security. For example, as shown in FIG. 1A, the rows of First Section 102 may correspond to securities, one security in each row, and the columns may correspond to parameters of the securities, one parameter in each column.

In some exemplary embodiments, each segment of First Section 102 may include: a Symbol Cell 104, for displaying the symbol designated in the market for the security in question; one or more Ask Amount Cells 106, Ask Price Cells 108, for displaying information such as ask volume and ask price, regarding ask orders that are pending in the market (e.g., ask orders that appear in the book of the market and are ready for execution); one or more Bid Amount Cells 110, Bid Price Cells 112, for displaying information such as bid price and bid volume, regarding bid orders that are pending in the market; one or more Last Deal Volume Cells 114; a Last Deal Price Cells (not shown), or the like for displaying information regarding one or more most recent transactions which were executed in the market, such as the price and the volume; a Day Volume Cell 118, for displaying a total amount of units purchased or sold during an entire trading day; and a Call or Put Cell 120, for displaying a trading position with respect to the security in question. In some cases, additional cells may be used. For example, cells which may be designated for derivative instruments, such as Call or Put Cell 120.

In some exemplary embodiments, each segment of First Section 102 may include one or more cells for displaying calculated parameters based on data in other cells, such as Ask Amount Cells 106, Ask Price Cells 108, Bid Amount Cells 110 and Bid Price Cells 112. For example, segments of First Section 102 may include a Spread Cell (not shown) for displaying a difference between a bid price displayed in a Bid Price Cell 112 and an ask price displayed in an Ask Price Cell 108.

In some exemplary embodiments, First Section 102 may be locked for user editing and access to the cells of the first section may be allowed on a read-only basis exclusively, for preventing the user from manually modifying the securities data.

In some exemplary embodiments, the securities data received and displayed in First Section 102 of Graphical User Interface 100 of the computerized trading system in accordance with the disclosed subject matter, may be obtained from a server of a trading system, which server may be connected to the computerized trading system via a computerized network. The server may be a server handling, monitoring, executing, or performing similar operations on trade orders. The server may or may not be a server of a market maker. In some exemplary embodiments, the server may be a server operated by a stock exchange, which is capable of receiving trade orders and providing real-time data, such as quote data, bid and ask data, or the like.

In some exemplary embodiments, the securities data displayed on First Section 102 may comprise data relating to one or more options, or likewise derivative instruments having a relatively short life span. The displayed data on First Section 102 may be updated by replacing an expired option on the expiration date by an equivalent option having the same parameters as the expired option but for a later expiration date with the same life span. For example, a weekly option set to expire on the weekend may be replaced at the beginning of the following week by an option with the same put/call position, strike price and underlying asset as the expired option, that is set to expire by the following weekend.

In some exemplary embodiments, First Section 102 may comprise one or more segments associated with the same security at different ticks, also referred to as timeline display of the security. Each segment may present information of the security at a tick, or an average information for a time duration, such as time between ticks. The timeline display of the security may display a timeline of securities data over a time period. In some exemplary embodiments, a user may define a number of ticks to be displayed, such as twenty ticks. As an example, in case the ticks are defined as every day, a row of cells may represent information regarding a specific day, such as closing price, average price, volume, etc. In case the user defines twenty ticks, there may be information regarding the security at the last 20 days. The timeline display may present a sliding window of the security and enable the user to define formulas which take into account historic information, such as the case may be when attempting to automatically perform technical analysis of a security. The formula which attempts to identify correct timing to send an order may refer to cells in the timeline display in order to take into account a trend over time. As another example, the tick frequency may be defined per any fixed time interval, including in a minute resolution to assist in day trading. As yet another example, the ticks may be defined based on events associated with the security (e.g., transaction completed, updated in the book, etc.) or the like.

In some exemplary embodiments, each of the one or more spreadsheets of Graphical User Interface 100 may comprise a Second Section 122 for receiving user input specifying one or more trading orders and setting conditions for executing them. Second Section 122 may comprise a plurality of segments of contiguous cells, for example a row or a column, such that each of which segments may be associated with a single trading order. Each cell of a segment may be associated with a parameter of the corresponding trading order. For example, as shown in FIG. 1B, the rows of Second Section 122 may correspond to trading orders, one order in each row, and the columns may correspond to parameters of the orders, one parameter in each column.

In some exemplary embodiments, each segment of Second Section 122 may include: an Execution Trigger Cell 124, for receiving user input setting a condition for executing the trading order; a Volume Cell 126, for receiving user input specifying a volume of the security to be traded; a Price Cell 128, for receiving user input specifying a price for the security in the trading order; and a Status Cell 130, for displaying an indication of the execution status of the trading order.

In some exemplary embodiments, the value of either of Execution Trigger Cell 124, Volume Cell 126, or Price Cell 128, may be defined using a formula which is a function of one or more values of other spreadsheet cells. The formula may be a function of a value of a securities data attribute of a security displayed in First Section 102. Such a formula allows the user to define the trading order based on securities data. For example, the value of Price Cell 128 in a segment of Second Section 122 may be defined using a formula referring to the value of Ask Amount Cell 106 in a segment of First Section 102. Additionally or alternatively, the formula may be a function of a value of a spreadsheet cell in a segment which relates to another trading order in Second Section 122. Such a formula allows the user to define the trading order based on other trading orders, whereby imposing a relation between them. For example, the value of Price Cell 128 in a segment associated with a first trading order may be defined using a formula referring to the value of Volume Cell 126 in a segment associated with a second trading order. A formula may refer to a cell in the same spreadsheet or in another spreadsheet. For example, a cell in a segment of Second Section 122 of a first spreadsheet may refer to a cell of either First Section 102 of the first spreadsheet, First Section 102 of a second spreadsheet, Second Section 122 of the first spreadsheet, or Second Section 122 of the second spreadsheet.

In some exemplary embodiments, the formula may be decomposed to atomic components and each of the components may be analyzed. A generalized formula based on the atomic components may be generated. The generalized formula may be retrieved and entered by a user as input to a cell in a segment of Second Section 122 to be applied on a selected security. In some exemplary embodiments, a formula may be analyzed by traversing in a Depth First Search (DFS) order, a Breadth First Search (BFS) order, or other order the expression tree and visiting any referred cell to be analyzed itself to define a spreadsheet-independent formula. Upon such traversal, when a cell providing a security data is encountered, the content of the cell may be replaced to the parameter of the security for which the security data is provided. The spreadsheet-based formula may be transformed into spreadsheet-independent formula which receives as parameters one or more securities' identification (e.g., symbols). As an example, consider the spreadsheet-based formula: ((A2+B2/2)+B4)/2 referring to cells A2, B2 and D4 of the spreadsheet. Assuming A2 contains bid price of security having symbol AAPL, B2 contains a formula (C2+0.5) referring to cell C2 which contains the ask price of the AAPL security, and B4 containing a bid price of a security having symbol GOOG, the disclosed subject matter may traverse the formula, visit each referred cell and translate the formula by replacing each reference and by identifying the referred information directly, to: (BID(AAPL)+(ASK(AAPL)+0.5)/2)+BID(GOOG). In some exemplary embodiments, the spreadsheet independent formula may be named and stored for later use, in a spreadsheet or in a different environment. The parameters of the spreadsheet independent formula may be the identifications of the symbols. Referring to the example above, the formula may be denoted as foo(S1, S2)=(BID(S1)+(ASK(S1)+0.5)/2)+BID(S2). It will be noted that the same formula may be used in a spreadsheet, such as by defining a content of a cell to be “=foo(E1,MSFT)”, where E1 is a cell including a symbol of a security and MSFT is a symbol of a security.

In some exemplary embodiments, the spreadsheet independent formula may be computed and used to execute the computations defined in a spreadsheet. Such execution may be performed without having a spreadsheet open. In some cases, presenting the spreadsheet and updating the spreadsheet may require system resources and thus the computation in a spreadsheet may be slower than in a spreadsheet independent mode. Hence, in some cases, execution may be performed in such a manner. It will be noted, however, that in some cases, the spreadsheet may be used to define the formula, test it and potentially execute it a number of times, while real-time batch execution may be performed in a spreadsheet-independent mode, in a batch process which may be executed in the background, in a server, or the like.

In some exemplary embodiments, for each segment of Second Section 122, an evaluation of the condition specified in Execution Trigger Cell 124 may be performed in order to determine whether the respective trading order is to be executed. Additionally or alternatively, the value may be defined manually, such as to TRUE or FALSE. In some exemplary embodiments, upon a determination that the condition of an Execution Trigger Cell 124 is met (e.g., the value is determined to be TRUE), the respective trading order may be sent to the market for execution. The trading order may be sent automatically responsive to Execution Trigger Cell 124 being evaluated as TRUE. Alternatively, the sending of the trading order may be semi-automated, by requiring user authorization prior to execution using alerts, prompts or the like. In some exemplary embodiments, after the trading order is completed successfully, Status Cell 130 may be updated accordingly. In some exemplary embodiments, execution of the trading order is simulated by updating Status Cell 130 to reflect completion of the trading order without sending the trading order for execution.

In some exemplary embodiments, the condition specified in Execution Trigger Cell 124 may relate to securities data of one or more parameters displayed in First Section 102, as detailed above. Additionally or alternatively, the condition may relate to a value of a cell of another segment of Second Section 122 being associated with the same or with a different trading order. In particular, the value of Execution Trigger Cell 124 may be defined based on a value of Status Cell 130 in a segment which relates to another trading order in Second Section 122. For example, Execution Trigger Cell 124 of one trading order may specify a condition of the execution of another trading order being completed, as may be indicated by Status Cell 130 of the other trading order, whereby a predetermined order of execution between different trading orders may be implemented.

In some exemplary embodiments, after Execution Trigger Cell 124 is evaluated to TRUE and the trading order is sent for execution and prior to the trading order being completed, the value of one or more cells of the segment associated with the trading order may be re-evaluated. Upon a determination that the value being changed, a modifying instruction to modify the trading order accordingly may be sent. The modifying instruction may be either an instruction to update the trading order sent, an instruction to execute a new trading order, or an instruction to cancel the trading order. For example, in case the condition of Execution Trigger Cell 124 is re-evaluated and determined to no longer being met (e.g., evaluated or manually modified to FALSE), a cancelation instruction to cancel the trading order may be sent to the market. Similarly, an update may be sent to reflect a changed price, or a new trading order may be sent to reflect an increased volume. In another example, in case the volume is reduced to or below the executed volume thus far, a cancelation instruction may be sent to cancel the remaining outstanding volume. Additionally or alternatively, there may be a minimal volume associated with a security. The modification may take into account the minimal volume such as in case the updated volume is below the minimal volume, a cancelation order may be transmitted or a modification order is provided to modify the volume to be the minimal volume.

In some exemplary embodiments, each segment of Second Section 122 may further include a Symbol Cell 134, for receiving user input specifying the symbol designated in the market for the security to which the associated trading order is directed.

In some exemplary embodiments, each segment of Second Section 122 may further include a Buy/Sell Cell 132, for receiving user input specifying whether the trading order is a buy order or sell order of the target security. In some exemplary embodiments, each segment of Second Section 122 may further include an Order Type Cell (not shown) for receiving user input specifying the type of the trading order, for example, a limit order, a market order, a fill or kill order and the like.

In some exemplary embodiments, each segment of Second Section 122 may further comprise one or more execution information cells displaying information of executions of the trading order, which cells may be automatically updated in response to the progress in execution of the trading order. In some exemplary embodiments, the execution information cell may display information relating to several iterations of the trading order, such as imposed by a strategy that is defined to repeat. The execution information cells may include, for example, an Executed Volume Cell 140, for displaying an executed volume of securities traded by the trading order being completed successfully in a current iteration; an Executed Price Cell 142, for displaying an execution price of securities traded by the trading order being completed successfully in a current iteration; a Pending Volume Cell (not shown) displaying a pending volume of securities to be traded by the trading order being sent for execution in a current iteration; a Pending Price Cell (not shown) displaying a pending price of securities to be traded by the trading order being sent for execution in a current iteration; an Aggregated Executed Volume Cell (not shown) displaying aggregated executed volume over all iterations of the trading order; an Aggregated Executed Price Cell (not shown) displaying average executed price over all iterations of the trading order; an Aggregated Pending Volume Cell (not shown) displaying aggregated pending volume over all iterations of the trading order; and an Aggregated Pending Price Cell (not shown) displaying average pending price over all iterations of the trading order.

In some exemplary embodiments, a value of a spreadsheet cell of a first segment of Second Section 122 associated with a first trading order, may be defined as a formula of a value of an execution information cell in a second segment of Second Section 122 associated with a second trading order, whereby the first trading order is defined after the second trading order is sent for execution and based on executed or pending values thereof. For example, the value of Volume Cell 126 of the first segment may be defined as the value of Executed Volume Cell 140 of the second segment, thereby imposing a constraint that an identical amount is traded in both of which corresponding orders. Additionally or alternatively, a predetermined ratio between the traded volumes may be imposed.

In some exemplary embodiments, some portions of Second Section 122 may be locked for user editing and access to them may be allowed on a read-only basis exclusively, for preventing the user from manually modifying the data. In some exemplary embodiments, Status Cell 130, Executed Volume Cell 140, Executed Price Cell 142, or the like may be locked for user modification.

In some exemplary embodiments, each of the one or more spreadsheets of Graphical User Interface 100 may comprise a Third Section 152 for receiving user input specifying one or more trading strategies. Third Section 152 may comprise a plurality of segments of contiguous cells, for example a row or a column, such that each of which segments may be associated with a single trading strategy. Each cell of a segment may be associated with a parameter of the corresponding trading strategy. For example, as shown in FIG. 1B, the rows of Third Section 152 may correspond to trading strategies, one strategy in each row, and the columns may correspond to parameters of the strategies, one parameter in each column.

In some exemplary embodiments, each segment of Third Section 152 may define a grouping of one or more trading orders. In some exemplary embodiments, grouping may be performed by indicating a set of segments, such as rows. Additionally or alternatively, the grouping may be defined by setting a set of cells and the strategy may include each trading order that is associated with any of the set of cells. In some exemplary embodiments, the set of cells may include one or more ranges of cells. Additionally or alternatively, the grouping may be defined by fragmenting Second Section 122 to fragments, each of which may be associated with a different strategy.

In some exemplary embodiments, each segment of Third Section 152 may comprise an Enable/Disable Cell. Acting upon the evaluated value of Execution Trigger Cells may be performed for trading orders associated with a trading strategy for which the Enable/Disable Cell is set to enable execution. Otherwise, if the Enable/Disable Cell is set to disable execution, trading orders associated with the trading strategy will not be executed nonetheless Execution Trigger Cells being evaluated to TRUE.

In some exemplary embodiments, each segment of Third Section 152 may comprise a Repetitive Cell 156, for receiving user input specifying a condition for repeating the associated trading strategy of the segment. The value of Repetitive Cell 156 may be defined using a formula. Upon the condition of Repetitive Cell 156 being met, a reset of Status Cells 130 of the one or more segments grouped by the trading strategy may be performed. Accordingly the trading orders defined by the one or more segments grouped by the trading strategy may consequently be reset for execution, and, upon the conditions in their respective Execution Trigger Cells 124 being met, the trading orders may be executed multiple times. The segments of Third Section 152 may each further comprise a Counter Cell 158, for indicating the number of times a reset of the Status Cells 130 of the one or more trading orders grouped by the trading strategy has been performed.

In some exemplary embodiments, each segment of Third Section 152 may comprise one or more of the following cells: a Turnover Cell (not shown) for displaying the turnover of the associated trading strategy; a Loss/Profit Cell (not shown) for displaying the sum earned or lost in trading per the associated trading strategy; and a Position/Exposure Cell (not shown) for displaying the share of the associated trading strategy out of a user's holdings portfolio. In some exemplary embodiments, the condition of Repetitive Cell 156 may be defined as a formula of the value of one or more of Turnover Cell, Loss/Profit Cell and Position/Exposure Cell.

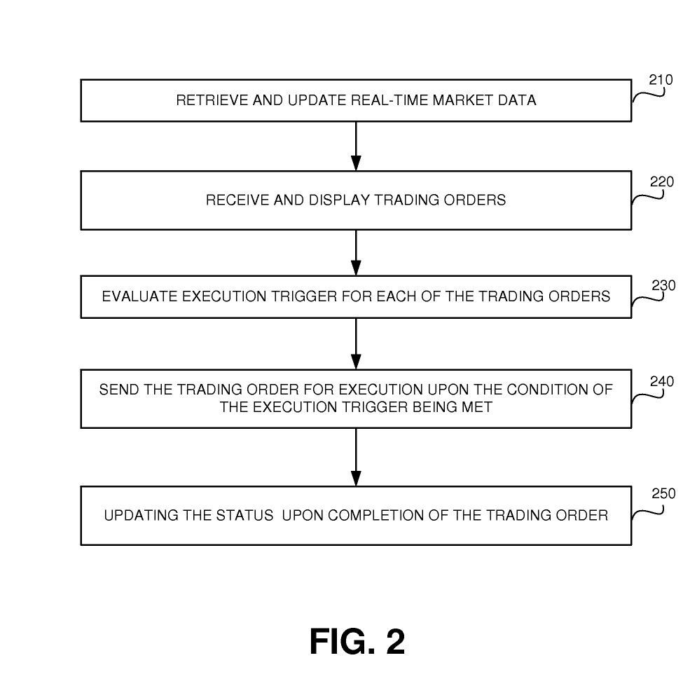

Referring now to FIG. 2 showing a flowchart diagram of a method in accordance with some exemplary embodiments of the disclosed subject matter.

On step 210, securities data of one or more securities are repeatedly retrieved and updated accordingly in a first section of a spreadsheet displayed by a graphical user interface of a computer, such as First Section 102 in Graphical User Interface 100 of FIGS. 1A-1B.

On step 220, one or more trading orders of the one or more securities are received and displayed in a second section of the spreadsheet, such as Second Section 122 of FIG. 1B, wherein each of which trading orders comprises an execution trigger parameter, a volume parameter, a price parameter and a status parameter. The execution trigger parameter defines a condition for executing the trading order, such as the value of Execution Trigger Cell 124 of FIG. 1B. The volume parameter defines a volume of the security to be traded, such as the value of Volume Cell 126 of FIG. 1B. The price parameter defines a price for the security in the trading order, such as the value of Price Cell 128 of FIG. 1B. The status parameter indicates an execution status of the trading order, such as the value of Status Cell 130 of FIG. 1B. Each trading order is defined in a segment of the second section, in which segment each parameter of the associated trading order is defined in a spreadsheet cell. In some exemplary embodiments, the user may define explicit values to cells or implicitly using formulas which are based on values of one or more other cells.

On step 230, the condition defined by execution trigger parameter of each trading order is evaluated. The condition may be defined using a formula which is a function of one or more values of other spreadsheet cells. The formula may be a function of a value of a securities data attribute of a security displayed in the first section, such as 102 of FIG. 1A. Additionally or alternatively, the formula may be a function of a value of a spreadsheet cell in a segment which relates to another trading order in the second section, such as 122 of FIG. 1B. For example, the formula may be a function of a parameter of another trading order.

In some exemplary embodiments, the execution trigger parameter may be evaluated only in case the trading order is enabled. The trading order may be manually disabled by the user, or disabled as part of an entire strategy not being enabled.

On Step 240, responsive to the condition of the execution trigger parameter being met, the trading order is sent to the market for execution. The order may be sent to a server of a trading system, which server may be connected to the computerized trading system via a computerized network.

On Step 250, in response to the trading order being completed successfully, the status parameter is updated in the spreadsheet to reflect the successful completion of the trading order.

Additionally or alternatively, prior to trading order being completed successfully, such as if the trading order is pending in the market waiting for a matching trading order (e.g. a buy order matching the sell order or vice versa), one or more parameters of the trading order may be re-evaluated, such as in case one or more values in cells which define the value of one of the parameters is modified. For example, in case the execution trigger parameter is defined based on market data displayed in a first section (e.g. 102 of FIG. 1A), a change in the securities data may cause the value of the execution trigger parameter to switch from TRUE to FALSE. In case the re-evaluated value of the one or more parameters is determined to have changed, a modification instruction may be sent to the market to modify accordingly the pending trading order which was sent on Step 240. The modifying instruction may be either an instruction to update the trading order sent, an instruction to execute a new trading order, or an instruction to cancel the trading order, as discussed above.

In some exemplary embodiments, a trading strategy may define a grouping of one or more trading orders received in the second section. Each trading strategy may comprise an enable/disable parameter. For each trading order grouped by the trading strategy, in case the enable/disable parameter is set to enable execution, an evaluation of the condition set by the respective execution trigger parameter is performed, similarly as in Step 230. Otherwise, in case the enable/disable parameter is set to disable execution, an evaluation of the condition set by the respective execution trigger parameter is avoided or such execution is performed but not acted upon. Responsive to a determination that the condition being met, the trading order is sent for execution, similarly as in Step 240. Upon successful completion of the trading order, the status parameter is updated accordingly, similarly as in Step 250.

In some exemplary embodiments, a trading strategy may comprise a repetitive parameter defining a condition for repeating execution of the trading orders of the trading strategy, such as in Repetitive Cell 156 of FIG. 1B. Responsive to a determination that the condition of the repetitive parameter being met, the status parameter of each of the trading orders grouped by the trading strategy is reset, whereby resetting the trading orders for execution, such that upon the conditions in their respective execution trigger cells being met, the trading orders are sent for execution once more, and so on, thus repeating Steps 230 to 250 for multiple times. In some exemplary embodiments, the repetitive parameter may be defined based on values of one or more status cells, so as to ensure that the trading strategy is repeated after all or some of the trading orders of the trading strategy are completed successfully.

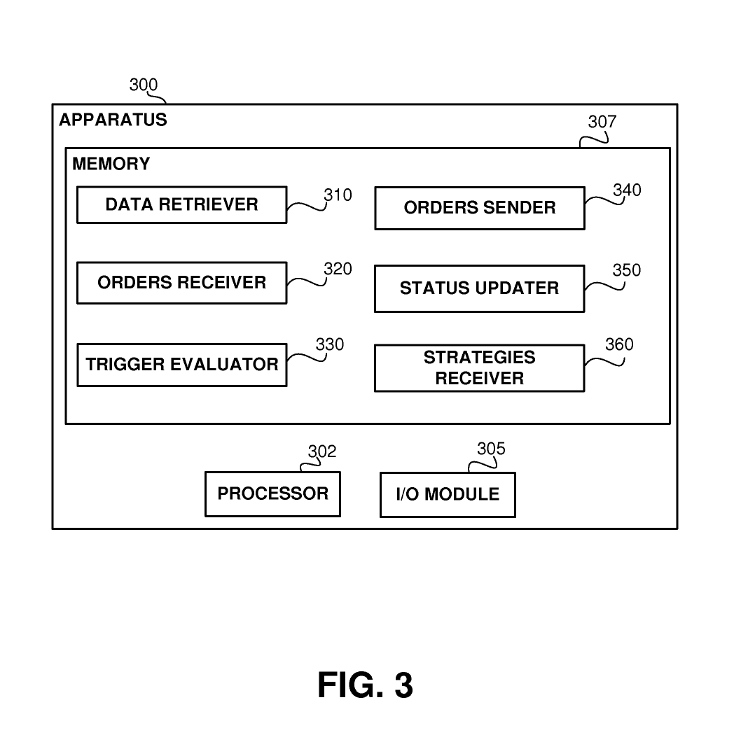

Referring now to FIG. 3 showing an Apparatus 300 in accordance with some exemplary embodiments of the disclosed subject matter.

Apparatus 300 may comprise one or more Processors 302. Any of Processors 302 may be a Central Processing Unit (CPU), a microprocessor, an electronic circuit, an Integrated Circuit (IC) or the like. Alternatively, Apparatus 300 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 302 may be utilized to perform computations required by Apparatus 300 or any of it subcomponents.

Apparatus 300 may comprise an Input/Output (I/O) Module 305. I/O Module 305 may be utilized to provide an output to and receive input from a user. I/O Module 305 may comprise a graphical user interface, such as 100 of FIGS. 1A-1B, configured to provide a workspace comprising one or more spreadsheets. I/O Module 305 may comprise a communication port for communicating with another apparatus or system in order to retrieve data from and send orders to one or more markets, accounts, or the like in real-time.

Apparatus 300 may comprise a Memory 307 for storing executable components, which may also contain data during execution of one or more components. Memory 307 may be persistent or volatile. For example, Memory 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory 307 may retain program code operative to cause any of Processors 302 to perform acts associated with any of the steps shown in FIG. 2 above, for example retrieving securities data, receiving trading orders, or others.

The components detailed below may be implemented as one or more sets of interrelated computer instructions, executed for example by any of Processors 302 or by another processor. The components may be arranged as one or more executable files, dynamic libraries, static libraries, methods, functions, services, or the like, programmed in any programming language and under any computing environment.

Memory 307 may comprise a Data Retriever 310 for repeatedly retrieving securities data of one or more securities. The retrieved data may be updated by Data Retriever 310 in first section of a spreadsheet displayed by the graphical user interface of I/O Module 305. In some exemplary embodiments, Data Retriever 310 may retrieve the data periodically, such as every 10 seconds, 1 second, every 20 milliseconds, or the like.

Memory 307 may comprise an Orders Receiver 320 for receiving one or more trading orders of the one or more securities, using the spreadsheet displayed by the graphical user interface of I/O Module 305. Each of the one or more trading orders received by Orders Receiver 320 comprises an execution trigger parameter defining a condition for executing the trading order, a volume parameter defining a volume of the security to be traded, a price parameter defining a price for the security in the trading order and a status parameter indicating an execution status of the trading order. Orders Receiver 320 may be configured to receive and display the trading orders in a second section of the spreadsheet, such that each trading order is defined in a segment of the second section, and each parameter of the trading order is defined in a spreadsheet cell of the segment. 25

Memory 307 may comprise a Trigger Evaluator 330, for evaluating the execution trigger parameter of each trading order. The execution trigger parameter may be defined using a formula which is a function of one or more values of other spreadsheet cells, in either of the first section or the second section displayed by the graphical user interface of I/O Module 305.

Memory 307 may comprise an Orders Sender 340 for sending the trading order to the market for execution, responsive to a determination by Trigger Evaluator 330 that the condition defined by the execution trigger parameter has been met.

Memory 307 may comprise a Status Updater 350 for updating the status parameter in response to the trading order being completed successfully, whereby Status Updater 350 updates the spreadsheet displayed by the graphical user interface of I/O Module 305 to reflect the successful completion of the trading order. In some exemplary embodiments, Status Updater 350 may be configured to update execution information cells in the spreadsheet relating to the executed trading order.

Memory 307 may comprise a Strategies Receiver 360 for receiving and displaying one or more trading strategies in a third section of the spreadsheet displayed by graphical user interface of I/O Module 305, wherein each of which trading strategies comprises a range parameter, wherein the range parameter indicates a range of the one or more trading orders received and displayed by Orders Receiver 320 in the second section of the spreadsheet. Strategies Receiver 360 may be configured to receive and display the trading strategies in segments, such that each segment is associated with a different trading strategy. Trigger Evaluator 330 may be further configured to evaluate the execution trigger parameter of each trading order indicated by the range parameter of each of the one or more trading strategies received by Strategies Receiver 360. Orders Sender 340 may be configured to send the trading order for execution, responsive to a determination by Trigger Evaluator 330 that the condition of the execution trigger parameter being met.

In some exemplary embodiments, each of which trading strategies received and displayed by Strategies Receiver 360 may further comprise a repetitive parameter defining a condition for repeating the trading strategy. Status Updater 350 may be further configured to reset the status parameter(s) of the one or more trading orders indicated by the range parameter, responsive to the condition of the repetitive parameter being met. Consequently, the trading orders indicated by the range parameter are reset for execution and upon a determination by Trigger Evaluator 330 that the conditions of their respective execution trigger parameters being met, the trading orders are sent by Orders Sender 340 for execution.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. 20

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized system comprising:
a graphical user interface configured to provide a workspace comprising one or more spreadsheets, each of the one or more spreadsheets comprising:
a first section comprising a plurality of spreadsheet cells for displaying securities data of one or more securities selected by a user;
a second section comprising a plurality of segments composed of spreadsheet cells for receiving one or more trading orders of one or more securities, wherein each segment is associated with a trading order of a security, wherein each segment comprises an execution trigger cell, a volume cell, a price cell and a status cell, wherein the execution trigger cell defines a condition for executing the trading order, wherein the volume cell defines a volume of the security to be traded, wherein the price cell defines a price for the security in the trading order, wherein the status cell indicates an execution status of the trading order;
a processor configured to repeatedly retrieve the securities data and update the first section;
wherein said processor is further configured to evaluate the execution trigger cell of each segment, wherein responsive to the condition of the execution trigger cell being met, said processor is configured to send the trading order for execution;
wherein said processor is further configured to update the status cell in response to the trading order being completed successfully.

2. The system of claim 1, wherein the securities data comprise at least one of: market data; and fundamental data.

3. The system of claim 1, wherein a value of at least one of the execution trigger cell, the volume cell and the price cell is defined using a formula which is a function of one or more values of other spreadsheet cells in the workspace.

4. The system of claim 3, wherein the formula is a function of a value of at least one of the following: a securities data attribute of a security displayed in the first section; and a spreadsheet cell in a segment which relates to another trading order.

5. The system of claim 3, wherein said processor is further configured to decompose the formula to atomic components and analyze each of the atomic components, said processor is configured to generate a generalized formula based on the atomic components, which generalized formula is retrievable by a user to be applied on a selected one or more securities when entered as input to a cell in a segment of said second section.

6. The system of claim 1, wherein a value of the execution trigger cell is defined based on a value of a status cell in a segment which relates to another trading order.

7. The system of claim 1, wherein said processor is further configured to: re-evaluate a value of a cell of a segment in which the condition of the execution trigger cell was evaluated to be met and prior to the trading order being completed;
responsive to the value being changed, sending a modifying instruction to modify the trading order accordingly.

8. The system of claim 1, wherein each segment further comprises:
a symbol cell defining a symbol of the security upon which the trading order is performed; and
a buy/sell cell defining whether the trading order is a buy order or a sell order.

9. The system of claim 1, wherein each segment further comprises one or more execution information cells displaying information of plurality of executions of the trading order, wherein said processor is further configured to update the one or more execution information cells in response to the progress in execution of the trading order.

10. The system of claim 9, wherein the one or more execution information cells comprise at least one of:
an executed volume cell displaying an executed volume of securities traded by the trading order being completed successfully in a current iteration;
an executed price cell displaying an execution price of securities traded by the trading order being completed successfully in a current iteration;
a pending volume cell displaying a pending volume of securities to be traded by the trading order being sent for execution in a current iteration;
a pending price cell displaying a pending price of securities to be traded by the trading order being sent for execution in a current iteration;
an aggregated executed volume cell displaying aggregated executed volume over all iterations;
an aggregated executed price cell displaying average executed price over all iterations;
an aggregated pending volume cell displaying aggregated pending volume over all iterations; and
an aggregated pending price cell displaying average pending price over all iterations.

11. The system of claim 9, wherein a value of at least one spreadsheet cell of a first segment associated with a first trading order is defined as a formula of a value of an execution information cell in a second segment associated with a second trading order, whereby the first trading order is defined after the second trading order is sent for execution and based on executed or pending values thereof.

12. The system of claim 1, wherein the securities data is obtained from a server of a trading system, wherein said server is connected to the computerized system via a computerized network.

13. The system of claim 1, wherein each of the one or more spreadsheets further comprising:
a third section comprising a plurality of segments composed of spreadsheet cells for receiving one or more trading strategies, wherein each segment is associated with a trading strategy, wherein each segment comprises an enable/disable cell, wherein each segment defines a grouping of one or more trading orders defined in the second segment; and
wherein said processor is further configured to avoid sending for execution the one or more trading orders which are associated with a trading strategy for which the enable/disable cell is set to disable execution.

14. The system of claim 1, wherein each of the one or more spreadsheets further comprises:
a third section comprising a plurality of segments composed of spreadsheet cells for receiving one or more trading strategies, wherein each segment is associated with a trading strategy, wherein each segment defines a grouping of one or more trading orders defined in the second segment; and
wherein each segment in the third section comprises a repetitive cell, wherein the repetitive cell defines a condition for repeating the trading strategy of the segment, wherein responsive to the condition of the repetitive cell being met, said processor is configured to reset the status cells of the one or more segments grouped by the trading strategy, whereby the trading orders defined by the one or more segments grouped by the trading strategy are reset for execution and upon the conditions in their respective execution trigger cells being met, the trading orders are executed.

15. The system of claim 1, wherein the securities comprise one or more options, wherein the processor is further configured to update the display in said first section by replacing a first option with a second option responsive to expiry of the first option, wherein the second option having the same put/call position, strike price and underlying asset as the first option, wherein the second option is set to expire on a later date than the first option.

16. The system of claim 1, wherein the first section comprising a plurality of segments for displaying a timeline of securities data of a security over a time period, wherein each segment is associated with a tick, wherein each segment comprises securities data of the security at the tick.

17. A computerized system comprising:
a graphical user interface configured to provide a workspace comprising one or more spreadsheets, each of the one or more spreadsheets comprising:
a first section comprising a plurality of spreadsheet cells for displaying securities data of one or more securities selected by a user;
a second section comprising a plurality of segments composed of spreadsheet cells for receiving one or more trading orders of one or more securities, wherein each segment is associated with a trading order of a security, wherein each segment comprises an execution trigger cell, a volume cell, a price cell and a status cell, wherein the execution trigger cell defines a condition for executing the trading order, wherein the volume cell defines a volume of the security to be traded, wherein the price cell defines a price for the security in the trading order, wherein the status cell indicates an execution status of the trading order;
a processor configured to repeatedly retrieve the securities data and update the first section based on a historic database;
wherein said processor is further configured to evaluate the execution trigger cell of each segment, wherein responsive to the condition of the execution trigger cell being met, said processor is configured to simulate execution of the trading order and update the status cell accordingly.

18. A computer-implemented method comprising:
repeatedly retrieving securities data of one or more securities and updating a first section of a spreadsheet, wherein the spreadsheet is displayed by a graphical user interface of a computer;
receiving, using the spreadsheet, one or more trading orders of the one or more securities, each of which trading orders comprises an execution trigger parameter, a volume parameter, a price parameter and a status parameter, wherein the execution trigger parameter defines a condition for executing the trading order, wherein the volume parameter defines a volume of the security to be traded, wherein the price parameter defines a price for the security in the trading order, wherein the status parameter indicates an execution status of the trading order, wherein the one or more trading orders are received and displayed in a second section of the spreadsheet, wherein each trading order is defined in a segment of the second section, wherein each parameter is defined in a spreadsheet cell;
evaluating the execution trigger parameter of each trading order;
responsive to the condition of the execution trigger parameter being met, sending the trading order for execution; and,
updating the status parameter in response to the trading order being completed successfully, whereby the spreadsheet is updated to reflect the successful completion of the trading order;
wherein said repeatedly retrieving, said receiving, said evaluating, said sending and said updating are performed by a processor.

19. The method of claim 18, wherein a value of at least one of the execution trigger parameter, the volume parameter and the price parameter is defined using a formula which is a function of one or more values of other parameters associated with the one or more trading orders as defined in the spreadsheet.

20. The method of claim 18, wherein a value of the execution trigger parameter is defined based on a value of a status parameter of another trading order.

21. The method of claim 18, further comprising performing by a processor:
re-evaluating one or more parameters of a trading order for which the condition of the execution trigger parameter was evaluated to be met and prior to the trading order being completed;
updating the spreadsheet according to the re-evaluated value of the one or more parameters; and
responsive to a value of the one or more parameters being changed, sending a modifying instruction to modify the trading order accordingly.

22. A computer program product comprising a computer readable storage medium retaining program instructions, which program instructions when read by a processor, cause the processor to perform the method of claim 18.
